(19) United States
(12) Patent Application Publication
(10) Pub. No.: US 2026/0154498 A1
(43) Pub. Date: Jun. 4, 2026

(54) METHOD AND SYSTEM FOR EXTRACTING ENTITIES FROM HETEROGENEOUS DATA SOURCES

(71) Applicant: LTI Mindtree Ltd, Mumbai (IN)

(72) Inventors: Brijesh Prabhakar, Mumbai (IN); ChandiPrasad Ojha, Mumbai (IN); Sagar Pise, Mumbai (IN)

(21) Appl. No.: 19/091,900

(22) Filed: Mar. 27, 2025

(30) Foreign Application Priority Data
Dec. 4, 2024 (IN) 202421095678

(51) Int. Cl. G06F 40/279; G06F 9/38; G06F 40/237; G06F 40/30

(52) U.S. Cl. CPC G06F 40/279; G06F 9/3888; G06F 40/237; G06F 40/30

(57) ABSTRACT

A method and system for extracting entities from heterogeneous data sources is disclosed. An input from the plurality of heterogeneous data sources is analyzed to determine a data format for each portion of the input data and select a corresponding extraction technique for each determined data format. Each portion of the input data is converted into a standardized text format using the selected extraction techniques to generate a plurality of contextual text blocks. A set of candidate entities is extracted from the plurality of contextual text blocks using a generative artificial intelligence model. The set of candidate entities is validated using a knowledge graph that utilizes a predefined ontology. An output is then generated comprising validated entities from the set of candidate entities and associated metadata.

### FIELD

Various embodiments of the present disclosure generally relate to extraction of entities. More particularly, the disclosure relates to a method and system for extracting entities from heterogeneous data sources.

### BACKGROUND

Entity extraction from heterogeneous data sources is fundamental to data analysis, knowledge management, and regulatory compliance. Contemporary organizations utilize diverse data repositories to derive actionable insights and fulfill operational requirements. These repositories encompass relational database management systems (RDBMS), NoSQL databases, cloud-based storage platforms, and various structured and unstructured file formats, including portable document format (PDF) files, word processing documents, spreadsheets, and proprietary application-generated formats.

The inherent complexity and diversity of these data sources present significant challenges for entity extraction. Each source type implements distinct structural paradigms, encoding methodologies, and metadata schemas, resulting in data representation inconsistencies and ambiguities. Moreover, variations within individual file formats introduce additional complexity, necessitating sophisticated extraction methodologies for accurate entity identification and interpretation.

Conventional entity extraction methodologies require substantial manual intervention throughout the process, including data annotation, model development, and output refinement. This manual dependency increases both temporal and resource requirements while demanding specialized expertise. Furthermore, achieving consistent accuracy remains problematic, particularly when processing diverse and complex data formats. Structural, syntactic, and semantic variations within these formats compound the extraction challenges, leading to inconsistent results.

Current entity extraction solutions generally fall into three categories: rule-based architecture, machine learning frameworks, and hybrid implementations. Rule-based architecture employs predetermined patterns and expressions to identify and extract entities. While effective for well-structured data formats, these systems exhibit limited adaptability to evolving data structures, constraining their scalability and effectiveness in dynamic environments.

Machine learning frameworks, particularly those incorporating natural language processing (NLP) capabilities, offer enhanced flexibility and generalization across diverse contexts. However, these frameworks necessitate extensive, high-quality training datasets, which are resource-intensive to generate. Additionally, such frameworks demonstrate reduced efficacy when processing unstructured or non-standard data formats lacking consistent patterns, such as digitized documents or multimedia content.

Hybrid implementations combine rule-based and machine learning approaches to leverage their respective advantages. While this integration enhances adaptability and accuracy, such implementations typically require substantial customization to address specific use case requirements, thereby increasing implementation complexity. Entity extraction from PDF documents exemplifies these challenges, as PDF files may incorporate plain text, embedded images, and multilingual content, each requiring distinct processing methodologies.

Traditional approaches encounter significant technical barriers when processing heterogeneous data formats, particularly in achieving consistent entity extraction accuracy while maintaining computational efficiency. These technical challenges are amplified when processing complex documents containing mixed content types, varied structural elements, and multiple languages.

The complexity of addressing these technical constraints while reducing manual intervention and implementation-specific customization represents a substantial challenge in the field of automated entity extraction.

### SUMMARY

The present disclosure provides a method and system for extracting entities from heterogeneous data sources. An input from the plurality of heterogeneous data sources is analyzed to determine a data format for each portion of the input data and select a corresponding extraction technique for each determined data format. Each portion of the input data is converted into a standardized text format using the selected extraction techniques to generate a plurality of contextual text blocks. A set of candidate entities is extracted from the plurality of contextual text blocks using a generative artificial intelligence model. The set of candidate entities is validated using a knowledge graph that utilizes a predefined ontology. An output is then generated comprising validated entities from the set of candidate entities and associated metadata.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment 100 within which various embodiments of the present disclosure may function.

FIG. 2 is a diagram that illustrates a block diagram of a system 104 for extracting entities from heterogeneous data sources, in accordance with an embodiment of the disclosure.

FIG. 3 is a diagram that illustrates a flow chart 300 for a method for extracting entities from heterogeneous data sources, in accordance with an embodiment of the disclosure.

### DETAILED DESCRIPTION

Pursuant to various embodiments, the method and system extracts entities from heterogeneous data sources. An input from the plurality of heterogeneous data sources is analyzed to determine a data format for each portion of the input data and select a corresponding extraction technique for each determined data format. Each portion of the input data is converted into a standardized text format using the selected extraction techniques to generate a plurality of contextual text blocks. A set of candidate entities is extracted from the plurality of contextual text blocks using a generative artificial intelligence model. The set of candidate entities is validated using a knowledge graph that utilizes a predefined ontology. An output is then generated comprising validated entities from the set of candidate entities and associated metadata.

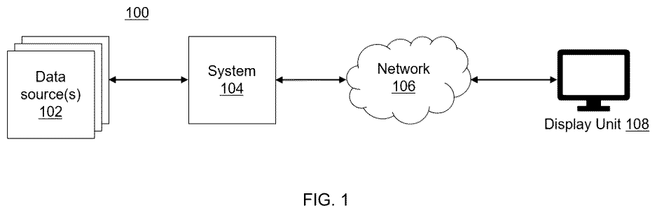

FIG. 1 is a diagram that illustrates an exemplary environment 100 within which various embodiments of the present disclosure may function. Referring to FIG. 1, the environment 100 comprises heterogeneous data sources 102, a system 104, a network 106, and a display unit 108.

In one or more embodiments, the system 104 is configured to extract entities from a diverse array of heterogeneous data sources 102, facilitating seamless integration and processing across various data formats. The heterogeneous data sources 102 may include structured databases such as relational databases (e.g., MySQL, PostgreSQL) with well-defined schemas, hierarchical databases, and time-series databases. The system 104 also handles semi-structured sources, such as document stores, markup language files (e.g., JSON, XML), email repositories, and log files, as well as unstructured sources, including text documents, image files containing embedded text, and streaming data feeds.

Additionally, the system 104 is configured to process data from cloud-based storage solutions and files in various structured and unstructured formats, including but not limited to comma-separated values, portable document format, word processing documents, and spreadsheet files. The system 104 further supports data streams originating from enterprise software systems, including resource planning systems, relationship management platforms, and API-based services, ensuring comprehensive data extraction capabilities across a wide spectrum of use cases.

In one or more embodiments, the system 104 may be configured to identify and extract entities from diverse data sources, where entities refer to distinct pieces of information or data units relevant to a particular application or context. Entities may represent objects, concepts, attributes, or relationships, depending on the domain and the use case.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other networks.

In one or more embodiments, the network 106 facilitates connection between the system 104 and the display unit 108 via one or more communication channels.

In one or more embodiments, the display unit 108 is configured to present the generated entities to a user in an interactive manner. The display unit 108 can include, but is not limited to, devices such as, interactive dashboards, touchscreen displays, projection systems, and wearable displays.

In some non-limiting embodiments, the display unit 108 can be located within an enterprise environment or at any other remote location, providing flexibility in accessing and presenting insights to users. For instance, in an enterprise setting, the display unit 108 could be integrated into centralized workstations or conference room systems, facilitating collaborative decision-making among teams. Conversely, in remote locations, the display unit 108 could be accessed via portable devices such as laptops, tablets, or smartphones, ensuring seamless connectivity and uninterrupted workflow regardless of the user's physical location.

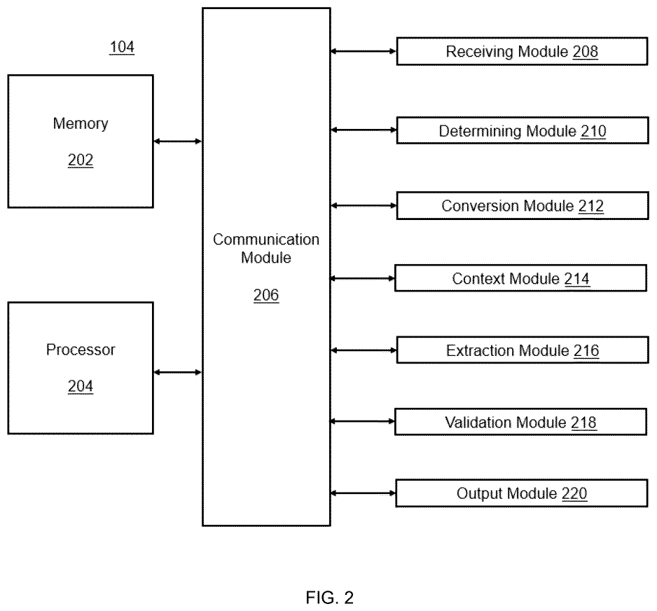

FIG. 2 is a diagram that illustrates a block diagram for the system 104 for extracting entities from the heterogeneous data sources 102, in accordance with an embodiment of the disclosure. Referring to FIG. 2, the system 104 includes a memory 202, a processor 204, and a plurality of functional modules including a communication module 206, a receiving module 208, a determining module 210, a conversion module 212, a context module 214, an extraction module 216, a validation module 218, and an output module 220.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 104 in accordance with various aspects of the present disclosure. The processor 204 may be further configured to communicate with various modules of the system 104 via the communication module 206.

The receiving module 208 may comprise suitable logic, code, and/or interfaces that may be configured to receive input data from the plurality of heterogeneous data sources 102. In one or more embodiments, the receiving module 208 may preprocess the incoming data by performing initial validations, such as format verification and integrity checks, to ensure compatibility with downstream processing modules.

In some non-limiting embodiments, the receiving module 208 is also configured to support integration of data streams from Application Programming Interfaces (APIs), third-party applications, and wide range of IoT devices. The receiving module 208 may be configured with adaptable interfaces capable of handling different data communication protocols, such as REST, SOAP, ODBC, JDBC, and FTP, ensuring compatibility with diverse systems.

In one or more embodiments, the receiving module 208 is configured to establish concurrent connections with multiple data sources, ensuring efficient and simultaneous data ingestion from heterogeneous origins. Once the data is received, it organizes the incoming information into source-specific processing queues, facilitating streamlined and parallel processing tailored to the unique characteristics of each data source.

The determining module 210 may comprise suitable logic, code, and/or interfaces that may be configured to determine a data format for each portion of the input data and select a corresponding extraction technique for each determined format.

In one or more embodiments, the extraction technique selection process utilizes a registry of extraction techniques that functions as a centralized repository of predefined and dynamically configurable extraction methods. The registry maintains extraction technique specifications, including associated data formats and operational parameters. The registry includes various extraction methodologies such as pattern-based extraction for structured data formats, natural language processing (NLP) based entity recognition for unstructured text, optical character recognition (OCR) for image-embedded documents, and graph-based algorithms for hierarchical data extraction. Each technique specification includes associated metadata defining supported formats, computational requirements, and operational dependencies.

In one or more embodiments, the determining module 210 may be configured to perform format-technique mapping by correlating determined data formats with compatible extraction techniques stored in the registry. This mapping process evaluates format characteristics against technique specifications to identify optimal extraction methods for each data portion.

In one or more embodiments, the extraction technique selection process includes dynamic parameter configuration based on input data characteristics, including but not limited to data volume, structural complexity, linguistic content, and associated metadata. These parameters optimize the selected extraction technique's performance for specific input.

In one or more embodiments, the determining module 210 may be configured to determine the data format for each portion by analyzing structural patterns within each portion of the input data. Structural patterns within the input data provide clues about its organization and encoding. For instance, for structured data, the determining module 210 may detect regular patterns such as tabular rows and columns in comma-separated files or key-value pairs in hierarchical document formats. For semi-structured data, the determining module 210 identifies recurring tags, delimiters, or indentation patterns to classify the data format. For unstructured data, the determining module 210 analyzes textual documents for determining patterns like sentence structure, paragraph alignment, or embedded metadata (e.g., fonts or styles).

In one or more embodiments, the determining module 210 may be configured to determine the data format for each portion by mapping the structural patterns to corresponding data formats. The mapping process involves analyzing the organization, syntax, and unique characteristics of the data and associating these features with predefined format categories. The structural patterns may include, but are not limited to, the arrangement of delimiters, key-value pairs, hierarchical nesting, and text encodings. The determining module 210 may be configured to employs a combination of heuristic rules, pattern recognition algorithms, and machine learning (ML) models to identify these patterns and map them to the most likely data format.

In one or more embodiments, the determining module 210 may be configured to determine the data format for each portion by identifying a data source type for each portion from a predefined set of data source types. The predefined set of data source types can be at least one of relational databases, document stores, file systems, and streaming sources.

In one or more embodiments, for relational databases, the determining module 210 may be configured to recognize structured data by analyzing connection details, schema definitions, or query interfaces. For data source types such as document stores, data from non-relational databases is identified based on document-oriented storage schemas or representational state transfer (REST) API interactions. For data source types such as file systems, the determining module 210 may be configured to inspect file extensions, multipurpose internet mail extensions (MIME) types, or embedded metadata to determine the source type. For data source types such as streaming sources, data streams are identified by evaluating real-time ingestion patterns, connection endpoints, and metadata related to event streaming.

The conversion module 212 may comprise suitable logic, code, and/or interfaces that may be configured to convert each portion of the input data into a standardized text format using the selected extraction techniques, which facilitates uniform processing of heterogeneous data, enabling downstream modules to perform entity extraction and analysis efficiently.

In one or more embodiments, the standardized text format serves as a unified representation of the input data, ensuring consistency while retaining essential contextual and structural information. The format includes content segments that preserve semantic boundaries, enabling maintenance of the logical flow and meaning of the original data. Structural markers are embedded to indicate content organization, such as headings, paragraphs, or tabular data, facilitating easier navigation and processing. Metadata fields are incorporated for source tracking, allowing each segment to be traced back to its originating data source. Additionally, format-specific attributes are retained, ensuring that nuances unique to the original data formats, such as font styles or embedded annotations, are not lost during the standardization process.

In one or more embodiments, the conversion process comprises multiple stages. First, the conversion module 212 applies each selected extraction technique to its corresponding portion of the input data. Each extraction technique is tailored to the data format identified by the determining module 210 to ensure the conversion process captures the content and context of the input data accurately.

Subsequently, the conversion module 212 normalizes the extracted content into the standardized text format. The normalization process transforms diverse data sources with varying structures, encodings, and formats into a consistent and unified representation. During this process, the conversion module 212 preserves source-specific metadata, ensuring that critical contextual information about the input data, such as its origin, timestamp, and source system attributes, remains attached to the extracted content.

The context module 214 may comprise suitable logic, code, and/or interface that may be configured to generate a plurality of contextual text blocks from the standardized text format while preserving semantic relationships between the contextual text blocks. By generating contextual text blocks, the context module 214 maintains the integrity of the information, enabling more accurate and meaningful downstream processing, such as entity extraction, knowledge graph construction, or data analysis.

In one or more embodiments, the context module 214 generates the plurality of contextual text blocks through a multi-stage process. Initially, the context module 214 identifies semantic boundaries within the standardized text format. These semantic boundaries represent points within the text where distinct concepts, ideas, or entities are introduced, separated, or changed. The boundaries define the logical flow of information and assist in segmenting the text into coherent units that can be processed and analyzed meaningfully.

In one or more embodiments, the context module 214 may be configured to determine block sizes based on predefined processing requirements. The size of each contextual text block is optimized to ensure that the extracted data can be processed efficiently and effectively for downstream tasks such as entity extraction, sentiment analysis, or knowledge graph construction.

In one or more embodiments, the context module 214 may be configured to establish references between related contextual text blocks during the generation process. These references facilitate the creation of a network of interconnected information, enabling analysis and development of semantic relationships between different blocks. This interconnected structure preserves the contextual relationships present in the original data while maintaining the advantages of block-based processing.

In one or more embodiments, the context module 214 may be configured to generate the plurality of contextual text blocks by implementing a lock optimization algorithm that determines token length constraints for the generative artificial intelligence model. The lock optimization algorithm is designed to balance the efficiency and effectiveness of data processing while ensuring that the generative artificial intelligence model can generate accurate and meaningful contextual text blocks.

In one or more embodiments, the generative artificial intelligence model includes a large language model (LLM) specifically trained for entity recognition tasks. The LLM operates within a defined context window, which specifies the maximum input token length that can be processed in a single operation, ensuring efficient handling of large or complex text inputs. The LLM incorporates entity extraction rules tailored to various data formats and domains, enabling precise identification of relevant entities. Additionally, the model integrates confidence scoring mechanisms, assigning reliability scores to extracted entities based on the strength of their contextual alignment and the accuracy of the recognition process.

In one or more embodiments, the LLM processes natural language inputs by analyzing linguistic and contextual cues derived from its training on extensive and diverse datasets. This analysis enables recognition of complex and domain-specific entities while maintaining contextual awareness across multiple text blocks. The model generates structured representations of identified entities, organizing them in formats that facilitate downstream processing and integration into broader data workflows.

In one or more embodiments, the context module 214 generates the plurality of contextual text blocks by implementing a lock optimization algorithm that maintains semantic completeness within each contextual text block. The lock optimization algorithm ensures that each generated block preserves the essential meaning and relationships between the entities and concepts in the input data while adhering to the constraints of token length and processing limitations of the generative artificial intelligence model.

In one or more embodiments, the context module 214 generates the plurality of contextual text blocks by implementing the lock optimization algorithm that preserves contextual relationships between adjacent contextual text blocks, to make the generated text blocks remain logically connected, maintaining the continuity and flow of information from one block to the next, which is crucial for the accurate interpretation and processing of the data by downstream systems.

The extraction module 216 may comprise suitable logic, code, and/or interface that may be configured to extract a set of candidate entities from the plurality of contextual text blocks using the generative artificial intelligence model.

In one or more embodiments, extracting the set of candidate entities includes initializing a plurality of parallel processing threads. The parallelized approach enables the system 104 to simultaneously analyze multiple portions of the input data, significantly speeding up the extraction process and enabling the handling of large datasets more effectively.

In one or more embodiments, extracting the set of candidate entities by the extraction module 216 includes distributing the plurality of contextual text blocks across the plurality of parallel processing threads. The extraction module 216 leverages a parallel processing framework that divides the input data into manageable contextual text blocks. Each block is a distinct portion of the standardized text, containing a subset of the data, such as a paragraph, sentence, or structured segment of information.

In one or more embodiments, extracting the set of candidate entities include combining entity extraction results from the plurality of parallel processing threads to form the set of candidate entities. The step consolidates the individual outputs from each parallel thread into a cohesive and comprehensive set of extracted entities, ensuring that no relevant data is missed and that all portions of the input data are accurately processed.

In one or more embodiments, using the generative artificial intelligence model for extracting the set of candidate entities include preprocessing each contextual text block of the plurality of contextual text blocks to conform to input requirements of the generative artificial intelligence model.

The preprocessing starts with normalizing the content of each contextual text block. The step standardizes various elements, such as dates, numerical values, and units of measurement, into a consistent format. For example, dates expressed in different formats like “MM/DD/YYYY” or “YYYY-MM-DD” are converted into a unified format, while numerical values are standardized to ensure uniformity. This normalization ensures that variations in the input data do not interfere with the model's ability to extract meaningful entities.

Following normalization, the text is tokenized, breaking the data down into smaller units like words or sub-words. Tokenization is crucial for preparing the data for the generative artificial intelligence model, as these models typically process text in the form of sequences of tokens. In certain instances, specialized tokenization techniques may be applied to handle domain-specific terms or multi-word expressions that are unique to the input data, ensuring that the model can better understand and process the text.

In one or more embodiments, using the generative artificial intelligence model for extracting the set of candidate entities include performing entity extraction operations using the generative artificial intelligence model on each preprocessed contextual text block. After preprocessing, the contextual text blocks are passed into the generative artificial intelligence model, where the model performs the task of extracting candidate entities from the text.

The entity extraction operations performed by the generative artificial intelligence model involve analyzing the structure and meaning of the text, identifying patterns, and recognizing specific types of entities. The entities may include, such as, but are not limited to, names of people, locations, organizations, dates, numbers, and other domain-specific terms.

The extraction process involves the generative artificial intelligence model interpreting the content in context. For example, if a text block contains a mention of “Apple” within a business context, the model may classify it as a company name. Similarly, the model may recognize the term “2024” as a date or “Paris” as a location, depending on how these terms are presented and their surrounding context.

The generative artificial intelligence model uses sophisticated language models, often based on deep learning techniques, such as transformers or attention mechanisms, to process the textual data. The techniques allow the generative artificial intelligence model to understand long-range dependencies within the text, enabling it to extract entities that are spread across different sections or sentences.

The entity extraction operations are performed iteratively for each preprocessed contextual text block. After processing a block, the generative artificial intelligence model generates a set of candidate entities, which may be further refined or validated based on predefined criteria. This process continues for each text block, allowing the system 104 to compile a comprehensive set of candidate entities across the entire input data set.

In one or more embodiments, using the generative artificial intelligence model for extracting the set of candidate entities include standardizing formats of the extracted candidate entities. After the generative artificial intelligence model identifies and extracts the candidate entities from the contextual text blocks, the next step involves transforming these entities into a consistent format. The standardization process is crucial for ensuring that the entities can be further processed, stored, and utilized across different systems without introducing inconsistencies or errors due to varied representations of the same entity.

Standardizing the formats of extracted candidate entities typically involves converting them into a predefined structure that aligns with the requirements of the downstream processes, databases, or applications that will use the entities. For instance, if the extraction process identifies multiple date entities, they may be standardized into a consistent date format, such as “YYYY-MM-DD,” regardless of how they were originally expressed in the text (e.g., “Mar. 3, 2024” or “03/03/2024”). Similarly, names of organizations or locations might be formatted consistently, removing any inconsistencies in capitalization, abbreviation, or other variations.

The validation module 218 may comprise suitable logic, code, and/or interface that may be configured to validate the set of candidate entities using a knowledge graph based on the predefined ontology. The knowledge graph serves as a structured representation of entities and their relationships, providing a semantic framework for verifying the accuracy and relevance of the extracted entities.

In one or more embodiments, the knowledge graph is a structured representation of interconnected data that includes nodes symbolizing validated entities and edges denoting the relationships between them. Each node is enriched with properties that define specific attributes of the entities, offering a detailed view of their characteristics. Confidence scores are associated with both the entities and their relationships, providing a quantitative measure of reliability derived from the validation process. Additionally, the knowledge graph incorporates temporal metadata, which specifies the validity periods for the entities and relationships.

In one or more embodiments, the predefined ontology includes a framework that includes entity type definitions, relationship type definitions, and hierarchical classification schemes. The elements establish a structured taxonomy that enables consistent categorization and interrelation of entities. Additionally, the ontology incorporates domain-specific rules tailored to the unique requirements of the application, ensuring accurate representation and contextual relevance. Validation constraints are also integrated into the ontology, providing a robust mechanism to assess the correctness and integrity of extracted entities and their relationships during the validation process.

In one or more embodiments, validating the set of candidate entities by the validation module 218 includes comparing each candidate entity of the set of candidate entities against entity definitions in the knowledge graph. This comparison involves analyzing the attributes, relationships, and contextual information of each candidate entity to determine its alignment with the predefined ontology encapsulated in the knowledge graph. By leveraging the rich semantic structure of the knowledge graph, the validation module 218 ensures that each candidate entity is accurately identified and associated with its correct type, scope, or category.

In one or more embodiments, validating the set of candidate entities by the validation module 218 includes verifying semantic relationships between the candidate entities using relationship definitions from the predefined ontology. Verifying involves assessing whether the identified relationships between entities align with the expected connections and constraints specified in the ontology. For example, if two candidate entities are a “Person” and a “Company,” the validation module 218 checks whether the relationship between them, such as “is employed by,” is valid according to the ontology's definitions.

In one or more embodiments, validating the set of candidate entities by the validation module 218 includes generating a confidence score for each candidate entity based on the comparing and verifying. The confidence score reflects the likelihood that a candidate entity is accurate and contextually relevant according to the knowledge graph and predefined ontology. During validation, the validation module 218 considers factors such as the degree of alignment with entity definitions, the accuracy of semantic relationships, and any inconsistencies identified during comparison. The resulting confidence score provides a quantitative measure of reliability for each entity, enabling the system 104 to prioritize or filter entities based on their validation strength.

In one or more embodiments, validating the set of candidate entities involves a multi-tiered validation approach to ensure both the accuracy and relevance of the extracted entities. The process begins with syntactic validation, where the structure and format of each entity are verified against predefined patterns or schemas. This step ensures that the entities conform to the expected syntactic rules, such as proper date formats or email address patterns. Following this, semantic validation is performed to confirm the meaning and contextual appropriateness of the entities within the broader dataset. This step evaluates whether the entities align with domain-specific terminologies and their intended usage.

Relationship validation is then applied to verify the associations between entities, ensuring that the relationships correspond to predefined rules or known patterns, such as hierarchical or referential linkages within a knowledge graph. In addition, temporal validation checks the validity periods of entities, ensuring they are relevant and accurate within their applicable time frames, such as ensuring license expiration dates are current. Finally, domain-specific validation leverages industry-specific rules and constraints to confirm the compliance and applicability of the entities to the targeted domain, such as adhering to financial regulations or medical terminologies.

In one or more embodiments, validated entities are identified from the set of candidate entities having confidence scores exceeding a predetermined threshold. This threshold acts as a benchmark to ensure only entities with sufficient reliability and alignment with the predefined ontology and knowledge graph are accepted as validated entities.

In one or more embodiments, the knowledge graph is updated to include the identified validated entities, ensuring that the system 104 remains dynamic and continually enriched with new, accurate information. By integrating the validated entities into the knowledge graph, the system 104 expands its semantic framework, enhancing its ability to recognize, validate, and relate entities in future data processing tasks.

In one or more embodiments, validation history data is stored for the identified validated entities and validation quality metrics are generated based on the confidence scores. The history includes details such as the original candidate entity, the associated confidence score, the validation steps performed, and the knowledge graph references used during validation. Additionally, validation quality metrics are generated based on the confidence scores of the validated entities.

The output module 220 may comprise suitable logic, code, and/or interface that may be configured to generate an output comprising validated entities from the set of candidate entities and associated metadata. This output serves as the final result of the entity extraction and validation processes, providing downstream systems or users with a structured and reliable dataset. The associated metadata may include details such as the source of each entity, its confidence score, relationships within the knowledge graph, and validation history. By delivering both the validated entities and their contextual metadata, the output module 220 facilitates transparency and improves the data's utility for applications such as analytics, decision-making, or further processing.

In one or more embodiments, the associated metadata generated by the output module 220 includes a rich set of contextual information to enhance the utility and traceability of the validated entities. The metadata comprises relationship mappings that define the semantic or hierarchical connections between the validated entities, providing a structured understanding of their interrelations. Additionally, each validated entity is accompanied by a confidence score that reflects its reliability based on the validation process.

Source identifiers are also included, indicating the specific origins of each validated entity across the plurality of heterogeneous data sources 102. The traceability allows users to understand the provenance of the data, which is critical for auditing and compliance purposes. Furthermore, temporal data is incorporated, detailing the timing of both the entity extraction and validation operations. The temporal information supports tracking and monitoring workflows, facilitating insights into processing timelines and enabling efficient debugging or optimization of the entity extraction pipeline.

In one or more embodiments, generating the output involves several steps designed to enhance the accessibility and usability of the validated entities and associated metadata. First, the validated entities are organized according to configurable organization criteria, which may include factors such as entity type, source, confidence score, or relational context.

In one or more embodiments, the output module 220 may be configured to format the validated entities and their associated metadata into a standardized structured representation. The structured output maintains hierarchical relationships, entity attributes, confidence scores, and source-specific metadata. The output format preserves data linkages while ensuring compatibility with downstream systems through standard data interchange formats.

Additionally, validation quality metrics are incorporated into the structured output format, providing insights into the overall performance of the entity extraction and validation process. The metrics may include information such as the distribution of confidence scores, validation success rates, and any anomalies detected during the validation process. By embedding the quality metrics directly into the output, users can gain a deeper understanding of the reliability and accuracy of the extracted entities, aiding in further analysis or decision-making.

In one or more embodiments, the validated entities undergo a scanning process to identify regulated data elements based on configurable data protection criteria. The criteria incorporate multiple regulatory frameworks and compliance standards, enabling the system 104 to detect sensitive or compliance-critical information, such as personally identifiable information (PII), financial data, healthcare records, and other regulated data types. Upon identification of regulated data elements, the system 104 applies corresponding data protection protocols based on configurable rule sets. The protection protocols implement multiple levels of data security controls, including but not limited to data transformation operations (e.g., masking, encryption) and access control mechanisms, with the specific protocols determined by the applicable regulatory requirements and data classification parameters.

Following the application of these protection rules, compliance metadata is generated to document the presence and handling of the regulated data elements. The metadata serves as an audit trail, providing details such as the type of regulated data identified, the specific protection rules applied, and timestamps of these operations. By including compliance metadata, the system 104 enhances transparency and accountability, enabling organizations to demonstrate adherence to data protection regulations and facilitating effective governance and risk management.

In one or more embodiments, the output module 220 may be configured to format the generated output based on pre-configured requirements, ensuring compatibility with various downstream systems and user preferences. Additionally, the output module 220 generates detailed processing reports that provide insights into the operations performed, such as validation metrics, data lineage, and entity extraction performance. To further optimize the delivery process, the output module 220 maintains output delivery queues, enabling seamless distribution of results to designated endpoints or applications while adhering to priority and scheduling requirements.

### EXAMPLE EMBODIMENT

Consider an exemplary embodiment illustrating the framework of the system 104 extracting and validating the entities from a variety of heterogeneous data sources 102.

In accordance with the exemplary embodiment, the receiving module 208 is responsible for receiving input data from a diverse range of data sources, which include relational databases, document stores, file systems, and streaming data feeds.
For example, the system 104 might receive data from a relational database containing customer records, a JSON file with transaction logs, and a PDF document containing legal agreements.

The receiving module 208 processes this data, ensuring compatibility with the system's 104 internal format by performing preliminary checks on data integrity and structure.

After receiving the input data, the determining module 210 analyzes each portion of the input data to determine its format. For instance, the relational database data might be structured in tables, the JSON file might contain semi-structured key-value pairs, and the PDF document might have a mix of structured text and unstructured image-based content. The determining module 210 uses predefined rules to map the data to its corresponding format and selects an appropriate extraction technique based on the format (e.g., text extraction for PDFs, table parsing for relational data).

The conversion module 212 is responsible for transforming the data into a standardized format that can be uniformly processed across different formats.
For example, the conversion module 212 may convert the relational database records into structured JSON objects, extract text from the PDF and convert it into a normalized text format, and parse the JSON transaction logs into a structured format.

Additionally, metadata such as source identifiers and temporal information may be preserved during this conversion process, ensuring that data provenance is maintained.

Once the data is standardized, the context module 214 analyzes the content and generates contextual text blocks. It identifies semantic boundaries, ensuring that entities are clearly defined within the context of the input data.
The context module 214 may create blocks of text such as “customer name,” “purchase amount,” or “transaction date,” which are contextually meaningful. In the case of unstructured data like PDFs, the context module 214 applies context-preserving algorithms to ensure that the relationships between entities (e.g., “customer A purchased product X on date Y”) are maintained in the output.

At this stage, the extraction module 216 leverages a large language model (LLM) trained specifically for entity recognition tasks. For example, the system 104 might extract entities such as “customer name,” “address,” “product name,” and “transaction value” from the contextual text blocks. The extraction module 216 uses advanced machine learning techniques, including deep learning models and rule-based approaches, to identify entities and assign appropriate labels (e.g., “customer name” as a PERSON entity, “product name” as a PRODUCT entity).

After the entities are extracted, the validation module 218 performs a multi-level validation process to ensure the quality and accuracy of the extracted entities. Based on the checks, confidence scores are generated for each entity, indicating its validity.

Finally, the output module 220 generates the final output, which consists of the validated entities and associated metadata.
For example: The output is formatted into a structured data format, such as JSON or XML, and includes the extracted entities along with their confidence scores, relationship mappings, source identifiers, and temporal data indicating when the entities were extracted and validated.

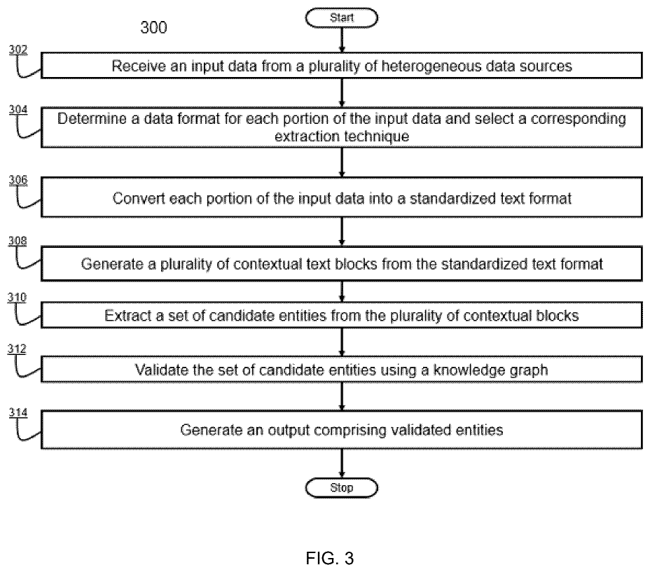

FIG. 3 is a diagram that illustrates a flow chart 300 for a method for extracting entities from the heterogeneous data sources 102, in accordance with an embodiment of the disclosure.

At 302, input data from the plurality of heterogeneous data sources 102 is received by the receiving module 208. In one or more embodiments, the receiving module 208 may preprocess the incoming data by performing initial validations, such as format verification and integrity checks, to ensure compatibility with downstream processing modules.

At 304, data format for each portion of the input data is determined and a corresponding extraction technique is selected for each determined data format by the determining module 210. In one or more embodiments, the extraction technique selection process utilizes a registry of extraction techniques that functions as a centralized repository of predefined and dynamically configurable extraction methods. The registry maintains extraction technique specifications, including associated data formats and operational parameters. The registry includes various extraction methodologies such as pattern-based extraction for structured data formats, natural language processing (NLP) based entity recognition for unstructured text, optical character recognition (OCR) for image-embedded documents, and graph-based algorithms for hierarchical data extraction. Each technique specification includes associated metadata defining supported formats, computational requirements, and operational dependencies.

In one or more embodiments, the determining module 210 may be configured to perform format-technique mapping by correlating determined data formats with compatible extraction techniques stored in the registry. This mapping process evaluates format characteristics against technique specifications to identify optimal extraction methods for each data portion.

In one or more embodiments, the extraction technique selection process includes dynamic parameter configuration based on input data characteristics, including but not limited to data volume, structural complexity, linguistic content, and associated metadata. These parameters optimize the selected extraction technique's performance for specific input.

In one or more embodiments, the determining module 210 may be configured to determine the data format for each portion by analyzing structural patterns within each portion of the input data. Structural patterns within the input data provide clues about its organization and encoding. For instance, for structured data, the determining module 210 may detect regular patterns such as tabular rows and columns in comma-separated files or key-value pairs in hierarchical document formats. For semi-structured data, the determining module 210 identifies recurring tags, delimiters, or indentation patterns to classify the data format. For unstructured data, the determining module 210 analyzes textual documents for determining patterns like sentence structure, paragraph alignment, or embedded metadata (e.g., fonts or styles).

In one or more embodiments, the determining module 210 may be configured to determine the data format for each portion by mapping the structural patterns to corresponding data formats. The mapping process involves analyzing the organization, syntax, and unique characteristics of the data and associating these features with predefined format categories. The structural patterns may include, but are not limited to, the arrangement of delimiters, key-value pairs, hierarchical nesting, and text encodings. The determining module 210 may be configured to employ a combination of heuristic rules, pattern recognition algorithms, and machine learning (ML) models to identify these patterns and map them to the most likely data format.

In one or more embodiments, the determining module 210 may be configured to determine the data format for each portion by identifying a data source type for each portion from a predefined set of data source types. The predefined set of data source types can be at least one of relational databases, document stores, file systems, and streaming sources.

In one or more embodiments, for relational databases, the determining module 210 may be configured to recognize structured data by analyzing connection details, schema definitions, or query interfaces. For data source types such as document stores, data from non-relational databases is identified based on document-oriented storage schemas or representational state transfer (REST) API interactions. For data source types such as file systems, the determining module 210 may be configured to inspect file extensions, multipurpose internet mail extensions (MIME) types, or embedded metadata to determine the source type. For data source types such as streaming sources, data streams are identified by evaluating real-time ingestion patterns, connection endpoints, and metadata related to event streaming.

At 306, each portion of the input data is converted into a standardized text format using the selected extraction techniques by the conversion module 212.

In one or more embodiments, the standardized text format serves as a unified representation of the input data, ensuring consistency while retaining essential contextual and structural information. The format includes content segments that preserve semantic boundaries, enabling maintenance of the logical flow and meaning of the original data. Structural markers are embedded to indicate content organization, such as headings, paragraphs, or tabular data, facilitating easier navigation and processing. Metadata fields are incorporated for source tracking, allowing each segment to be traced back to its originating data source. Additionally, format-specific attributes are retained, ensuring that nuances unique to the original data formats, such as font styles or embedded annotations, are not lost during the standardization process.

In one or more embodiments, converting each portion of the input data by the conversion module 212 may include applying each selected extraction technique to its corresponding portion of the input data. Each extraction technique is tailored to the data format identified by the determining module 210 to ensure conversion process captures the content and context of the input data accurately.

In one or more embodiments, the conversion process comprises multiple stages. First, the conversion module 212 applies each selected extraction technique to its corresponding portion of the input data. Each extraction technique is tailored to the data format identified by the determining module 210 to ensure the conversion process captures the content and context of the input data accurately.

Subsequently, the conversion module 212 normalizes the extracted content into the standardized text format. The normalization process transforms diverse data sources with varying structures, encodings, and formats into a consistent and unified representation. During this process, the conversion module 212 preserves source-specific metadata, ensuring that critical contextual information about the input data, such as its origin, timestamp, and source system attributes, remains attached to the extracted content.

At 308, a plurality of contextual text blocks are generated by the context module 214 from the standardized text format while preserving semantic relationships between the contextual text blocks.

In one or more embodiments, the context module 214 generates the plurality of contextual text blocks through a multi-stage process. Initially, the context module 214 identifies semantic boundaries within the standardized text format. These semantic boundaries represent points within the text where distinct concepts, ideas, or entities are introduced, separated, or changed. The boundaries define the logical flow of information and assist in segmenting the text into coherent units that can be processed and analyzed meaningfully.

In one or more embodiments, generating the plurality of contextual text blocks by the context module 214 include determining block sizes based on predefined processing requirements. The size of each contextual text block is optimized to ensure that the extracted data can be processed efficiently and effectively for downstream tasks such as entity extraction, sentiment analysis, or knowledge graph construction.

In one or more embodiments, generating the plurality of contextual text blocks by the context module 214 include establishing references between related contextual text blocks. These references facilitate the creation of a network of interconnected information, enabling analysis and development of semantic relationships between different blocks. This interconnected structure preserves the contextual relationships present in the original data while maintaining the advantages of block-based processing.

In one or more embodiments, the context module 214 generates the plurality of contextual text blocks by implementing a lock optimization algorithm that determines token length constraints for the generative artificial intelligence model. The lock optimization algorithm is designed to balance the efficiency and effectiveness of data processing while ensuring that the generative artificial intelligence model can generate accurate and meaningful contextual text blocks.

In one or more embodiments, the generative artificial intelligence model comprises a large language model (LLM) specifically trained for entity recognition tasks. The LLM operates within a defined context window, which specifies the maximum input token length that can be processed in a single operation, ensuring efficient handling of large or complex text inputs. The LLM incorporates entity extraction rules tailored to various data formats and domains, enabling precise identification of relevant entities. Additionally, the model integrates confidence scoring mechanisms, assigning reliability scores to extracted entities based on the strength of their contextual alignment and the accuracy of the recognition process.

At 310, a set of candidate entities are extracted from the plurality of contextual text blocks using a generative artificial intelligence model.

In one or more embodiments, extracting the set of candidate entities include initializing a plurality of parallel processing threads. The parallelized approach enables the system 104 to simultaneously analyze multiple portions of the input data, significantly speeding up the extraction process and enabling the handling of large datasets more effectively.

In one or more embodiments, extracting the set of candidates by the extraction module 216 include distributing the plurality of contextual text blocks across the plurality of parallel processing threads. The extraction module 216 leverages a parallel processing framework that divides the input data into manageable contextual text blocks. Each block is a distinct portion of the standardized text, containing a subset of the data, such as a paragraph, sentence, or structured segment of information.

In one or more embodiments, extracting the set of candidate entities include combining entity extraction results from the plurality of parallel processing threads to form the set of candidate entities. The step consolidates the individual outputs from each parallel thread into a cohesive and comprehensive set of extracted entities, ensuring that no relevant data is missed and that all portions of the input data are accurately processed.

In one or more embodiments, using the generative artificial intelligence model for extracting the set of candidate entities include preprocessing each contextual text block of the plurality of contextual text blocks to conform to input requirements of the generative artificial intelligence model.

The preprocessing starts with normalizing the content of each contextual text block. The step standardizes various elements, such as dates, numerical values, and units of measurement, into a consistent format. For example, dates expressed in different formats like “MM/DD/YYYY” or “YYYY-MM-DD” are converted into a unified format, while numerical values are standardized to ensure uniformity. This normalization ensures that variations in the input data do not interfere with the model's ability to extract meaningful entities.

Following normalization, the text is tokenized, breaking the data down into smaller units like words or sub-words. Tokenization is crucial for preparing the data for the generative artificial intelligence model, as these models typically process text in the form of sequences of tokens. In certain instances, specialized tokenization techniques may be applied to handle domain-specific terms or multi-word expressions that are unique to the input data, ensuring that the model can better understand and process the text.

At 312, the set of candidate entities are validated by the validation module 218 using the knowledge graph. The knowledge graph serves as a structured representation of entities and their relationships, providing a semantic framework for verifying the accuracy and relevance of the extracted entities.

In one or more embodiments, the knowledge graph is a structured representation of interconnected data that includes nodes symbolizing validated entities and edges denoting the relationships between them. Each node is enriched with properties that define specific attributes of the entities, offering a detailed view of their characteristics. Confidence scores are associated with both the entities and their relationships, providing a quantitative measure of reliability derived from the validation process. Additionally, the knowledge graph incorporates temporal metadata, which specifies the validity periods for the entities and relationships.

In one or more embodiments, the predefined ontology includes a framework that includes entity type definitions, relationship type definitions, and hierarchical classification schemes. The elements establish a structured taxonomy that enables consistent categorization and interrelation of entities. Additionally, the ontology incorporates domain-specific rules tailored to the unique requirements of the application, ensuring accurate representation and contextual relevance. Validation constraints are also integrated into the ontology, providing a robust mechanism to assess the correctness and integrity of extracted entities and their relationships during the validation process.

In one or more embodiments, validating the set of candidate entities by the validation module 218 includes comparing each candidate entity of the set of candidate entities against entity definitions in the knowledge graph. This comparison involves analyzing the attributes, relationships, and contextual information of each candidate entity to determine its alignment with the predefined ontology encapsulated in the knowledge graph. By leveraging the rich semantic structure of the knowledge graph, the validation module 218 ensures that each candidate entity is accurately identified and associated with its correct type, scope, or category.

In one or more embodiments, validating the set of candidate entities by the validation module 218 includes verifying semantic relationships between the candidate entities using relationship definitions from the predefined ontology. Verifying involves assessing whether the identified relationships between entities align with the expected connections and constraints specified in the ontology. For example, if two candidate entities are a “Person” and a “Company,” the validation module 218 checks whether the relationship between them, such as “is employed by,” is valid according to the ontology's definitions.

In one or more embodiments, validating the set of candidate entities by the validation module 218 includes generating a confidence score for each candidate entity based on the comparing and verifying. The confidence score reflects the likelihood that a candidate entity is accurate and contextually relevant according to the knowledge graph and predefined ontology. During validation, the validation module 218 considers factors such as the degree of alignment with entity definitions, the accuracy of semantic relationships, and any inconsistencies identified during comparison. The resulting confidence score provides a quantitative measure of reliability for each entity, enabling the system 104 to prioritize or filter entities based on their validation strength.

In one or more embodiments, validating the set of candidate entities involves a multi-tiered validation approach to ensure both the accuracy and relevance of the extracted entities. The process begins with syntactic validation, where the structure and format of each entity are verified against predefined patterns or schemas. This step ensures that the entities conform to the expected syntactic rules, such as proper date formats or email address patterns. Following this, semantic validation is performed to confirm the meaning and contextual appropriateness of the entities within the broader dataset. This step evaluates whether the entities align with domain-specific terminologies and their intended usage.

Relationship validation is then applied to verify the associations between entities, ensuring that the relationships correspond to predefined rules or known patterns, such as hierarchical or referential linkages within a knowledge graph. In addition, temporal validation checks the validity periods of entities, ensuring they are relevant and accurate within their applicable time frames, such as ensuring license expiration dates are current. Finally, domain-specific validation leverages industry-specific rules and constraints to confirm the compliance and applicability of the entities to the targeted domain, such as adhering to financial regulations or medical terminologies.

In one or more embodiments, validated entities are identified from the set of candidate entities having confidence scores exceeding a predetermined threshold. This threshold acts as a benchmark to ensure only entities with sufficient reliability and alignment with the predefined ontology and knowledge graph are accepted as validated entities.

In one or more embodiments, the knowledge graph is updated to include the identified validated entities, ensuring that the system 104 remains dynamic and continually enriched with new, accurate information. By integrating the validated entities into the knowledge graph, the system 104 expands its semantic framework, enhancing its ability to recognize, validate, and relate entities in future data processing tasks.

At 314, an output comprising validated entities is generated from the set of candidate entities and associated metadata. This output serves as the final result of the entity extraction and validation processes, providing downstream systems or users with a structured and reliable dataset. The associated metadata may include details such as the source of each entity, its confidence score, relationships within the knowledge graph, and validation history. By delivering both the validated entities and their contextual metadata, the output module 220 facilitates transparency and improves the data's utility for applications such as analytics, decision-making, or further processing.

In one or more embodiments, the associated metadata generated by the output module 220 includes a rich set of contextual information to enhance the utility and traceability of the validated entities. The metadata comprises relationship mappings that define the semantic or hierarchical connections between the validated entities, providing a structured understanding of their interrelations. Additionally, each validated entity is accompanied by a confidence score that reflects its reliability based on the validation process.

Source identifiers are also included, indicating the specific origins of each validated entity across the plurality of heterogeneous data sources 102. The traceability allows users to understand the provenance of the data, which is critical for auditing and compliance purposes. Furthermore, temporal data is incorporated, detailing the timing of both the entity extraction and validation operations. The temporal information supports tracking and monitoring workflows, facilitating insights into processing timelines and enabling efficient debugging or optimization of the entity extraction pipeline.

In one or more embodiments, generating the output involves several steps designed to enhance the accessibility and usability of the validated entities and associated metadata. First, the validated entities are organized according to configurable organization criteria, which may include factors such as entity type, source, confidence score, or relational context.

The method and system is advantageous in that it provides a hybrid approach that leverages the strengths of generative AI, ontologies, and knowledge graphs to deliver a robust and highly accurate entity extraction solution. Generative AI models bring advanced text processing capabilities, enabling the system to handle unstructured and semi-structured data effectively, while the use of predefined ontologies ensures consistent and structured understanding of domain-specific data. Knowledge graphs add an additional layer of validation, allowing for semantic relationships and contextual accuracy to be verified against established domain knowledge.

This method and system employs advanced text processing techniques combined with context-aware algorithms to ensure precise entity extraction and validation, even across heterogeneous and complex data formats. By reducing reliance on manual effort, the method and system not only enhances accuracy but also significantly improves scalability and efficiency, making it ideal for dynamic, large-scale data processing environments.

Significantly, the method and system, by utilizing a hybrid approach, efficiently support heterogeneous data sources. The system processes data from relational database management systems (RDBMS), non-relational databases, cloud-based storage systems, and multiple file format types. The hybrid approach incorporates format-specific processing modules, enabling operations across varied data structures and encoding.

Additionally, the system utilizes an ontology as a ground truth, providing a structured framework for defining entity types, relationships, and domain-specific rules. Combined with the use of knowledge graphs for validation, this ensures accurate and contextually relevant entity extraction. Additionally, the system incorporates a sensitive data discovery step, enabling the identification and handling of regulated data elements to ensure compliance with data protection standards and enhance security.

Furthermore, the queue-based parallel processing architecture enables the system to handle large volumes of data with speed and efficiency. By distributing tasks across multiple processing threads and managing them in a queue, the system ensures optimal resource utilization and scalability. The architecture makes the solution particularly suitable for organizations dealing with extensive data processing requirements, ensuring timely and reliable results even under high data load conditions.

The system's modular design and API compatibility provide seamless integration into existing workflows, enabling organizations to enhance their data processing capabilities without requiring significant changes to their current infrastructure. The adaptability ensures that the system can be deployed in diverse operational environments, allowing organizations to leverage its advanced features while maintaining continuity in their established processes.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for extracting entities from heterogeneous data sources, comprising:
receiving, by a processor, input data from a plurality of heterogeneous data sources;
determining, by the processor, a data format for each portion of the input data and selecting a corresponding extraction technique for each determined data format;
converting, by the processor, each portion of the input data into a standardized text format using the selected extraction techniques;
generating, by the processor, a plurality of contextual text blocks from the standardized text format while preserving semantic relationships between the contextual text blocks;
extracting, by the one or more processors, a set of candidate entities from the plurality of contextual text blocks using a generative artificial intelligence model;
validating, by the processor, the set of candidate entities using a knowledge graph, wherein the knowledge graph is based on a predefined ontology; and
generating, by the processor, an output comprising validated entities from the set of candidate entities and associated metadata.

2. The method of claim 1, wherein determining the data format for each portion comprises:
analyzing structural patterns within each portion of the input data;
identifying a data source type for each portion from a predefined set of data source types, wherein the predefined set of data source types comprises at least one of relational databases, document stores, file systems, and streaming sources; and
mapping the structural patterns to corresponding data formats.

3. The method of claim 1, wherein selecting the corresponding extraction technique comprises:
accessing a registry of extraction techniques;
matching each determined data format to a corresponding extraction technique from the registry; and
configuring extraction parameters for each matched extraction technique based on characteristics of the input data.

4. The method of claim 1, wherein converting each portion of the input data comprises:
applying each selected extraction technique to its corresponding portion of the input data;
normalizing extracted content into the standardized text format; and
preserving source-specific metadata during the converting.

5. The method of claim 1, wherein generating the plurality of contextual text blocks comprises:
identifying semantic boundaries within the standardized text format;
determining block sizes based on predefined processing requirements; and
establishing references between related contextual text blocks.

6. The method of claim 5, wherein generating the plurality of contextual text blocks further comprises implementing a block optimization algorithm that:
determines token length constraints for the generative artificial intelligence model;
maintains semantic completeness within each contextual text block; and
preserves contextual relationships between adjacent contextual text blocks.

7. The method of claim 1, wherein extracting the set of candidate entities comprises:
initializing a plurality of parallel processing threads;
distributing the plurality of contextual text blocks across the plurality of parallel processing threads; and
combining entity extraction results from the plurality of parallel processing threads to form the set of candidate entities.

8. The method of claim 7, wherein using the generative artificial intelligence model comprises:
preprocessing each contextual text block of the plurality of contextual text blocks to conform to input requirements of the generative artificial intelligence model;
performing entity extraction operations using the generative artificial intelligence model on each preprocessed contextual text block; and
standardizing formats of the extracted candidate entities.

9. The method of claim 1, wherein validating the set of candidate entities comprises:
comparing each candidate entity of the set of candidate entities against entity definitions in the knowledge graph;
verifying semantic relationships between the candidate entities using relationship definitions from the predefined ontology; and
generating a confidence score for each candidate entity based on the comparing and verifying.

10. The method of claim 9, further comprising:
identifying validated entities from the set of candidate entities having confidence scores exceeding a predetermined threshold;
updating the knowledge graph to include the identified validated entities;
storing validation history data for the identified validated entities; and
generating validation quality metrics based on the confidence scores.

11. The method of claim 1, wherein the associated metadata comprises:
relationship mappings between the validated entities;
confidence scores for each validated entity;
source identifiers indicating origins of each validated entity in the plurality of heterogeneous data sources; and
temporal data indicating timing of entity extraction and validation operations.

12. The method of claim 1, wherein generating the output comprises:
organizing the validated entities according to configurable organization criteria;
formatting the validated entities and the associated metadata into a structured output format; and
incorporating validation quality metrics into the structured output format.

13. The method of claim 1, further comprising:
scanning the validated entities to identify regulated data elements based on predefined data protection criteria;
applying data protection rules to the identified regulated data elements; and
generating compliance metadata indicating presence and handling of the regulated data elements.

14. The method of claim 1, wherein the plurality of heterogeneous data sources comprises:
structured data sources comprising relational databases with defined schemas, hierarchical databases, and time-series databases; semi-structured data sources comprising document stores, markup language files, email repositories, and log files; and unstructured data sources comprising text documents, image files with embedded text, and streaming data feeds.

15. The method of claim 1, wherein the predefined ontology comprises entity type definitions, relationship type definitions, hierarchical classification schemes, domain-specific rules, and validation constraints.

16. The method of claim 1, wherein the knowledge graph comprises nodes representing validated entities, edges representing relationships between entities, properties defining entity attributes, confidence scores for entities and relationships, and temporal metadata indicating validity periods.

17. The method of claim 1, wherein the standardized text format comprises content segments with preserved semantic boundaries, structural markers indicating content organization, metadata fields for source tracking, and format-specific attributes.

18. The method of claim 1, wherein the contextual text blocks comprise semantic units of content, token count constraints, context preservation markers, relationship indicators between blocks, and source reference metadata.

19. The method of claim 1, wherein validating the set of candidate entities comprises applying multiple validation levels comprising:
syntactic validation verifying entity structure and format;
semantic validation confirming entity meaning and context;
relationship validation verifying entity associations;
temporal validation checking entity validity periods; and
domain-specific validation applying industry rules.

20. A system for extracting entities from heterogeneous data sources, comprising:
a memory storing instructions that, when executed by a processor, cause the processor to:
receive input data from a plurality of heterogeneous data sources;
determine a data format for each portion of the input data and select a corresponding extraction technique for each determined data format;
convert each portion of the input data into a standardized text format using the selected extraction techniques;
generate a plurality of contextual text blocks from the standardized text format while preserving semantic relationships between the contextual text blocks;
extract a set of candidate entities from the plurality of contextual text blocks using a generative artificial intelligence model;
validate the set of candidate entities using a knowledge graph, wherein the knowledge graph is based on a predefined ontology; and
generate an output comprising validated entities from the set of candidate entities and associated metadata.

21. The system of claim 20, wherein the processor is configured to:
establish concurrent connections with the plurality of heterogeneous data sources;
organize incoming data into source-specific processing queues.

22. The system of claim 20, wherein the processor is configured to:
analyze incoming data streams for format identification;
dynamically select and configure extraction techniques;
manage parallel extraction processes; and
monitor extraction quality metrics.

23. The system of claim 20, wherein the processor is configured to:
segment standardized text into optimized blocks;
maintain contextual links between related segments;
adjust block sizes based on processing load; and
manage block distribution for parallel processing.

24. The system of claim 20, wherein the processor is configured to:
prepare contextual blocks for model processing;
manage model inference operations;
handle batch processing of blocks; and
aggregate entity extraction results.

25. The system of claim 20, wherein the processor is configured to:
execute multi-stage validation checks;
maintain validation state information;
update knowledge graph with new entities; and
generate validation quality metrics.

26. The system of claim 20, wherein the processor is configured to:
scan extracted entities for regulated data patterns;
apply appropriate protection rules;
track compliance status; and
generate compliance audit trails.

27. The system of claim 20, wherein the processor is configured to:
aggregate validated entities from multiple processing streams;
format output based on configured requirements;
generate processing reports; and
maintain output delivery queues.
